(19) United States
(12) Patent Application Publication
(10) Pub. No.: US 2025/0085759 A1
(43) Pub. Date: Mar. 13, 2025

(54) SYSTEMS AND METHODS FOR DETECTION OF POWER METER MISCONFIGURATIONS

(71) Applicant: Socomec Inc., Watertown, MA (US)

(72) Inventors: Arne LaVen, Bend, OR (US); Sudha LaVen, Bend, OR (US)

(73) Assignee: Socomec Inc., Watertown, MA (US)

(21) Appl. No.: 18/243,619

(22) Filed: Sep. 7, 2023

(51) Int. Cl. G06F 1/30

(52) U.S. Cl. CPC G06F 1/30

(57) ABSTRACT

A power meter for monitoring power signals from power lines is disclosed including a plurality of sensors coupled to at least one power line and configured to sense at least one parameter of at least one power signal carried by power line. At least one processor is configured to receive sensor data indicative of measurements of the at least one power signal by the plurality of sensors, to calculate a plurality of power values indicating an plurality of power values indicating at least an amount of power expected, based on the sensor data, to have been delivered through the at least one power line for a correct configuration of the plurality of sensors, a first misconfiguration of the plurality of sensors, and a second misconfiguration of the plurality of sensors, and to compare the plurality of power values to identify a current misconfiguration of the plurality of sensors.

### FIELD

The present subject matter generally relates to systems and methods for detection of power meter misconfigurations.

### BACKGROUND

Presently, power meters monitor power delivery system by taking voltage measurements and current measures of lines at the destination using several current or voltage sensors connected to the power lines. However, metering installations are often performed while power is shut off at the destination, leading to conditions that promote errors such as poor lighting, performing the work too quickly, or having limited trained installers. In many cases, the power load being measured may not be running at the time of installation and cannot be verified until a later time. Without correction of these errors, use of the power load measurements and associated data is impaired. Currently, correction of these errors often requires sending a trained technician to the home or business to diagnose and correct the errors, which is expensive and time consuming.

### BRIEF DESCRIPTION

According to some aspects of the present disclosure, a power meter for monitoring power signals from power lines includes a plurality of sensors coupled to at least one power line and configured to sense at least one parameter of at least one power signal carried by the at least one power line. At least one processor is configured to receive sensor data indicative of measurements of the at least one power signal by the plurality of sensors, and the at least one processor configured to calculate a plurality of power values indicating an amount of power expected, based on the sensor data, to have been delivered through the at least one power line for a respective configuration of the plurality of sensors including at least a first power value indicating an amount of power expected, based on the sensor data, to have been delivered through the at least one power line for a correct configuration of the plurality of sensors; a second power value indicating an amount of power expected, based on the sensor data, to have been delivered through the at least one power line for a first misconfiguration of the plurality of sensors; and a third power value indicating an amount of power expected, based on the sensor data, to have been delivered through the at least one power line for a second misconfiguration of the plurality of sensors. The at least one processor is further configured to compare the plurality of power values, including at least the first power value, the second power value, and the third power value, and to identify a current misconfiguration of the plurality of sensors based on a comparison of the plurality of power values.

According to some aspects of the present disclosure, a power monitoring system for monitoring power signals from power lines includes at least one power line for carrying at least one power signal, a plurality of sensors coupled to the at least one power line and configured to sense at least one parameter of the at least one power signal, and at least one processor configured to receive sensor data indicative of measurements of the at least one power signal by the plurality of sensors. The at least one processor is configured to calculate a plurality of power values indicating an amount of power expected, based on the sensor data, to have been delivered through the at least one power line for a respective configuration of the plurality of sensors including at least a first power value indicating an amount of power expected, based on the sensor data, to have been delivered through the at least one power line for a correct configuration of the plurality of sensors; a second power value indicating an amount of power expected, based on the sensor data, to have been delivered through the at least one power line for a first misconfiguration of the plurality of sensors; and a third power value indicating an amount of power expected, based on the sensor data, to have been delivered through the at least one power line for a second misconfiguration of the plurality of sensors. The at least one processer is further configured to compare the plurality of power values, including at least the first power value, the second power value, and the third power value, and to identify a current misconfiguration of the plurality of sensors based on a comparison of the plurality of power values.

According to some aspects of the present disclosure, a computer implemented method, includes receiving sensor data from a plurality of sensors installed on at least one power line, the plurality of sensors configured to sense at least one parameter of at least one power signal carried by the at least one power line. The method further includes a step of calculating a plurality of power values using a vector dot product multiplication of the sensor data, including at least a first power value indicating an amount of power expected, based on the sensor data, to have been delivered through the at least one power line for a correct configuration of the plurality of sensors; a second power value indicating an amount of power expected, based on the sensor data, to have been delivered through the at least one power line for a first misconfiguration of the plurality of sensors; and a third power value indicating an amount of power expected, based on the sensor data, to have been delivered through the at least one power line for a second misconfiguration of the plurality of sensors, comparing the plurality of power values, including at least the first power value, the second power value, and the third power value, and identifying a current misconfiguration of the plurality of sensors based on the comparison of the plurality of power values.

According to some aspects of the present disclosure, a non-transitory computer readable medium includes instructions that, when executed by one or more processors, cause the one or more processors to receive sensor data from a plurality of sensors installed on at least one power line, the plurality of sensors configured to sense at least one parameter of at least one power signal carried by the at least one power line, and apply to the sensor data a set of matrix masks including a plurality of matrix masks including at least a first matrix mask correlated with a correct configuration of the plurality of sensors, a second matrix masks correlated with a first misconfiguration of the plurality of sensors, and a third matrix mask correlated with a second misconfiguration of the plurality of sensors. The one or more processors are further caused to perform a vector dot product multiplication of each matrix masks of the plurality of matrix masks with the sensor data to calculate a plurality of power values indicating an amount of power expected, based on the sensor data and the plurality of matrix masks, to have been delivered through the at least one power line, wherein the plurality of power values includes at least (1) a first power value indicating an amount of power expected, based on the sensor data and the first matrix mask, to have been delivered through the at least one power line for the correct configuration, (2) a second power value indicating an amount of power expected, based on the sensor data and the second matrix mask, to have been delivered by the at least one power line for the first misconfiguration of the plurality of sensors, and (3) a third power value indicating an amount of power expected, based on the sensor data and the third matrix mask, to have been delivered by the at least one power line for the second misconfiguration of the plurality of sensors. The non-transitory computer readable medium further causes the one or more processors to select one of the first misconfiguration and the second misconfiguration as being a current misconfiguration of the plurality of sensors.

These and other features, aspects, and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 is a block diagram illustrating a power energy monitoring apparatus, according to various examples.

FIG. 2 is a block diagram illustrating a power energy monitoring board of the power energy monitoring apparatus of FIG. 1, according to various examples.

FIG. 3 is a block diagram illustrating a controller of the power energy monitoring board of FIG. 2, according to various examples.

FIG. 4 is a graphical representation of a set of matrix masks for 48 potential combinations of installation errors.

FIG. 5 is a graphical representation of an exemplary vector diagram corresponding with one of the set of matrix masks of FIG. 4.

FIG. 6 is a graphical representation of power values calculate from sensor data where each value is a unique value calculated by application of a unique matrix mask of the 48 matrix masks of FIG. 4.

FIG. 7 is an exemplary output device display showing an as-installed case and first and second potential solution configurations, according to various examples.

FIG. 8 is a flow chart showing a method for determining if a power energy monitoring apparatus is correctly installed, according to various examples.

Repeat use of reference characters in the present specification and drawings is intended to represent the same or analogous features or elements of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The present disclosure generally pertains to systems and methods for detection of power meter misconfigurations within a power monitoring system, specifically for detection of power meter misconfigurations installed on a power delivery system. In various examples, a power monitoring system comprises a plurality of sensors connected to power lines carrying electrical power to one or more destinations. A controller of a power meter within the power monitoring system is configured to collect sensor data from the sensors. Each sensor is configured to provide an analog sensor signal for a power variable, such as for, example, current or voltage. The controller comprises a plurality of sampling chips (e.g., analog-to-digital digital converters), and each sampling chip samples the sensor signal or signals from one or more of the sensors. The controller collects the sensor data from the sampling chips and stores the sensor data into memory. The controller may be configured to analyze the sensor data to determine whether the sensors are correctly installed on the power lines. The controller may also be configured to transmit to a remote server data indicative of possible errors in the configuration of the sensors. A user may use such data to determine if there is an installation error regarding the sensors. In various examples, the user may use such data to determine physical corrections needed regarding the placement of the sensors on the input. lines. In other examples, the user may use such data to remotely communicate with the controller to correct the installation errors in data without physically moving the sensors, or the controller may be configured to automatically correct such errors without user involvement.

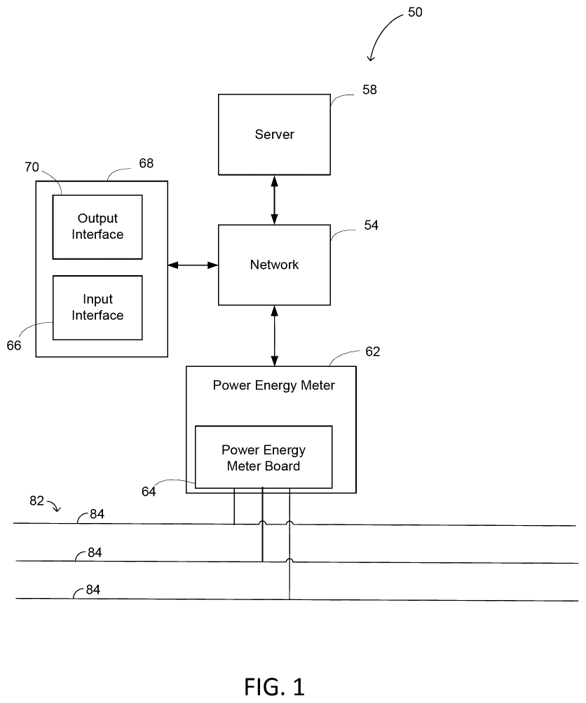

FIG. 1 illustrates a power monitoring system 50 having a power energy meter 62 at a facility such as a retail store, warehouse, or other destination receiving power via a set 82 of power lines 84. For example, as shown, the set 82 of powerlines 84 may include three-phase power lines 84 carrying three-phase power signals, but in other embodiments, system 50 may have any number of power lines 84 carrying power signals of various types. As shown in FIG. 1, the system 50 may include a network 54 in communication with a server 58, and the power energy meter 62 may have a power energy meter board 64 (e.g., a printed circuit board (PCB)) on which components of the power energy meter 62 reside and coupled to the power lines 84, as described in more detail elsewhere herein.

The server 58 may reside locally or remotely from the meter 62. The server 58 may include logic for controlling operations within the server 58, including monitoring the power signals carried by the power lines 84 based on information received from the meter 62.

In various examples, the power monitoring system 50 may further include a computing device 68 including an input device 66 and/or an output device 70 (e.g., a user device such as a mobile phone, computer, etc.). The computing device 68 may be in communication with the network 54, as shown in FIG. 1, and may be configured to act as a display to display information from the meter 62, as discussed in more detail elsewhere herein.

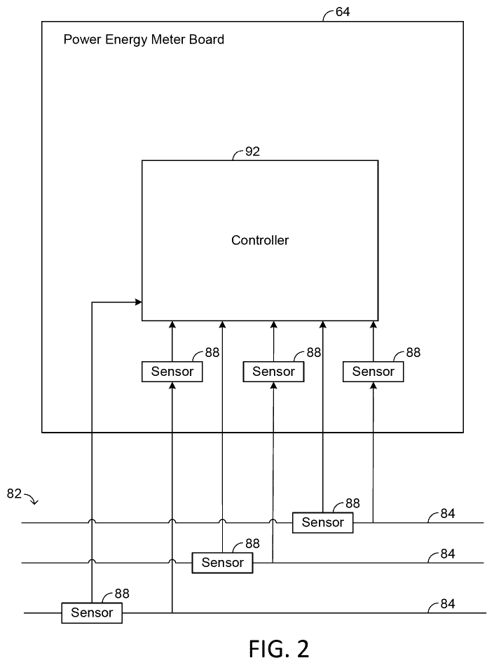

As shown in FIG. 2, the power meter 62 may include the power energy meter board 64 and may be electrically coupled with one or more power lines 84 (e.g., a set 82 of power lines 84). For example, the set 82 of power lines 84 may comprise three-phase power lines 84 carrying three alternating current (AC) power signals, where the power signal of each line 84 has a phase difference of about 120 degrees relative to the AC power signals carried by the other two lines 84 of the set 82. However, in other embodiments, the set 82 may comprise other numbers of power lines 82 and carry other types of power signals.

As shown in FIG. 2, each of the power lines 84 may be coupled with one or more respective sensors 88 configured to measure various power variables of each AC signal transmitted across the respective power line 84. For example, each sensor 88 may be configured to measure current and/or voltage of the AC signal of the respective power line 84. Each sensor 88 may be located on a power line 84 or may be located on the power meter board 64, as shown in FIG. 2. For illustrative purposes, it will be assumed hereafter unless otherwise indicated that the set 82 of power lines 84 include three power lines respectively carrying three power signals (e.g., three-phase power signals). In such an embodiment, each power line 84 may be coupled to a current sensor and a voltage sensor, such that there are a total of six sensors 88. However, it should be emphasized that other numbers of power lines 84 and sensors 88 are possible in other embodiments.

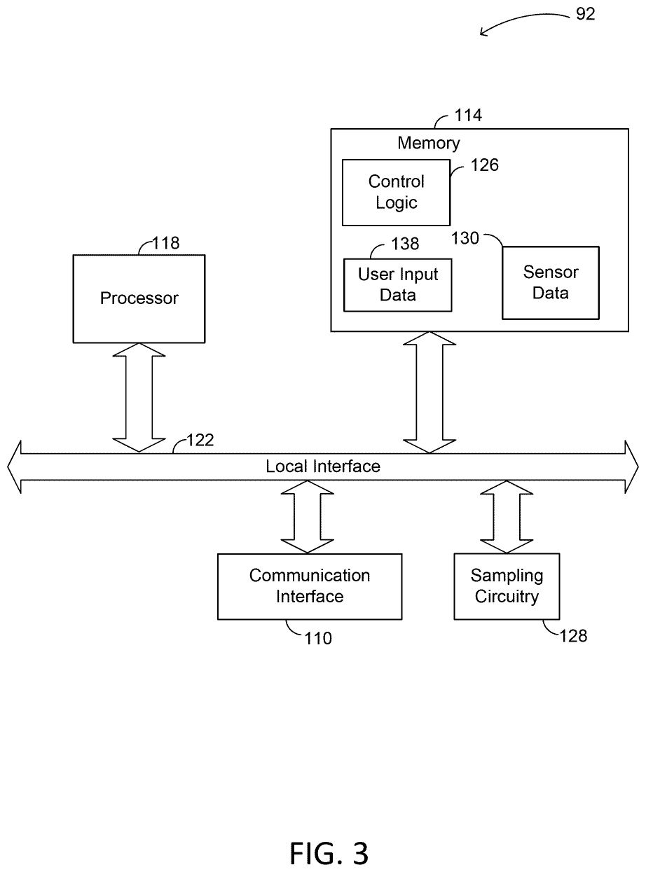

Each of the sensors 88 may be communicatively coupled with a controller 92, which is shown in more detail in FIG. 3. The controller 92 is configured to collect sensor data 130 from the sensors 88 and to analyze the sensor data 130 to monitor the power signals carried by the power lines 84. For example, the controller 92 may receive many samples of the sensor data 130 over time and analyze such samples to calculate an amount of electrical power delivered by the power lines 84 (e.g., total power or current delivered over one or more windows of time). Note that each sample of sensor data 130 may include an amount of data indicative of a measurement by each sensor 88 connected to the power lines 84. As shown in FIG. 2, the controller 92 may be positioned on the power energy meter board 64. However, it will be understood that the controller 92 may be positioned on or otherwise electrically coupled with the power energy meter board 64 without departing from the scope of the present disclosure. In addition, it is possible for the controller 69 to be located over disparate locations. As an example, a portion of the controller 92 for collecting sensor data 130 from the sensors 88 may be on the board 64 or otherwise near the sensors 88 while a portion of the controller 92 for analyzing the sensor data 130 may be located elsewhere, such as off the board 64 or at a remote location (e.g., at the server 58).

As shown by FIG. 3, the controller 92 may include a communication interface 110, such as at least one modem or other type transceiver, may be interfaced with, and used to exchange data with, the network 54 (FIG. 1). In various examples, the network 54 may comprise a local area network (LAN), a wide area network (WAN), such as the Internet, and/or other types of networks. As an example, when the network 54 comprises the Internet, the communication interface 110 may transmit messages from the controller 92 in accordance with transmission control protocol/Internet protocol (TCP/IP) or other format compatible with the Internet. If the network 54 comprises a cellular network, the interface 110 may be configured to wirelessly transmit messages from the controller 92 via cellular signals. In various examples, the communication interface 110 may be configured to communicate through the network 54 with the server 00 to convey information about the sensor data 130 and any identified misconfigurations of the sensors 88.

The controller 92 depicted by FIG. 3 includes at least one conventional processor 118, such as a digital signal processor (DSP) or a central processing unit (CPU), that communicates to and drives the other elements within the controller 92 via a local interface 122, which can include at least one bus. As an example, the processor 118 may be implemented with a conventional microprocessor that is configured to retrieve and execute instructions stored in the memory 114.

The controller 92 comprises control logic 126 for generally controlling the operation of the controller 92, as will be described in more detail hereafter. The control logic 126 can be implemented in software, hardware, firmware or any combination thereof. In the exemplary controller 92 illustrated by FIG. 3, the control logic 126 is implemented in software and stored in memory 114 of the controller 92.

Note that the control logic 126, when implemented in software, can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The control logic 126 is configured to receive data from the sensors 88 and control (e.g., establish and update) the sensor data 130 stored in the memory 114 of the controller 92. For example, the control logic 126 may be in communication with sampling circuitry 128. The sampling circuitry 128 may include one or more analog-to-digital converters configured to take a sample of one or more sensor signals, where each sensor signal is indicative of a power variable (e.g., current or voltage) of a power signal sensed by a sensor 88. The control logic 126 may be configured to control when the sampling circuitry 128 takes a sample of each respective power variable, and such sample is then stored within the memory 114 of the controller 92 as a sample of sensor data 130. The control logic 126 may be configured to process the sensor data 130 received, and the sensor data 130 may be recorded over time as power domain variables for each of the power lines 84 to create datasets for power and/or energy monitoring stored in the memory 114 of the controller 92.

The control logic 126 may further be configured to use the measured values of voltage and current from the sensor data 130 to calculate power domain variables (i.e., power/energy and/or VAR/active energy) and/or energy domain variables (i.e., the average of the collected power domain variables such as current, voltage, power/energy and/or VAR/active energy) for each of the power lines 84. For example, the control logic 126 may be configured to calculate power/energy using a vector dot product of the voltage and current measurements using the following formula:

$$Circuit Power = \vec{{ι}_{1}} \cdot \vec{{L}_{1}} + \vec{{ι}_{2}} \cdot \vec{{L}_{2}} + \vec{{ι}_{3}} \cdot \vec{{L}_{3}}$$

where i₁, i₂, and is, are measurements taken by the respective sensors 88 on first, second, and third power lines 84 of the set 82, and L₁, L₂, and L₃, are measurements of the line voltage of the power lines 84 of the set 82.

The control logic 126 may also be configured to calculate VAR/active energy using the vector cross product of the voltage and current measurements as shown in the formula:

$$Circuit Power = \vec{{ι}_{1}} \times \vec{{L}_{1}} + \vec{{ι}_{2}} \times \vec{{L}_{2}} + \vec{{ι}_{3}} \times \vec{{L}_{3}}$$

where i₁, i₂, and i₃, are measurements taken by the respective sensors 88 on first, second, and third power lines 84 of the set 82, and L₁, L₂, and L₃, are measurements of the line voltage of the power lines 84 of the set 82. The control logic 126 is configured to identify a set 82 of power lines 84 with a positive value for calculated VAR as an inductive system with a motor load and is further configured to identify a set 82 of power lines 84 with a negative value for calculate VAR as a capacitive system with an electronic load. Once the sensor data 130 has been received by the controller 92, the control logic 126 may be configured to transmit the sensor data 130 and calculations of the power domain variables and/or the energy domain variables to the server 58 via the network interface 110 and network 54.

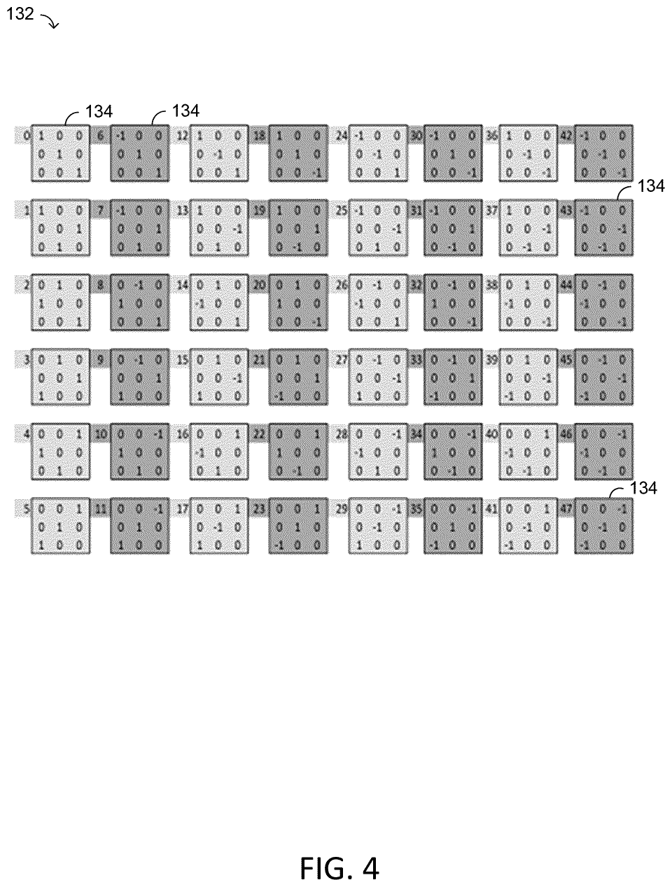

As explained in more detail with reference to FIGS. 4-7, the control logic 126 may further be configured to utilize the sensor data 130 and the calculated values for the power domain variables and/or the energy domain variables to determine if the sensors 88 are properly installed. In various examples, the control logic 126 may be configured to use real-time sensor data 130 (i.e., the power domain variables for each of the power lines 84) received by the controller 92 from the sensors 88 in calculations to determine if the sensors 88 are properly installed. In other examples, the control logic 126 may be configured to use stored sensor data 130 to determine averages of power domain variables over time (i.e., the energy domain variables for each of the power lines 84) in calculations to determine if the sensors 88 are properly installed.

In determining whether the sensors 88 are properly installed, the control logic 126 may be configured to utilize sets of possible misconfigurations to determine if one of the misconfigurations has occurred. For example, in a set 82 of three power lines 84 as shown with each power line 84 coupled to a respective sensor 88 (e.g., a current sensor or a voltage sensor), there may be a total of 48 combination of errors in installation (i.e., a total of 47 potential misconfigurations and 1 configuration in which no errors occurred, referred to herein as Index “0”) checked by the control logic 126, accounting for both phase and polarity errors. In other words, the installation configuration of the sensors 88 is one of 48 ways the sensors 88 could be installed. This may be determined using the probability of installing any one sensor 88 incorrectly (i.e., on the incorrect power line 84 (a phase error) or backwards on the respective power line 84 (a polarity error)).

Because errors in installation are not random but are instead linear combinations of known errors with each potential error having a calculatable impact on the results calculated or computed from the sensor data 130, each combination of errors may be assigned a unique matrix mask 134 capturing both the phase and polarity errors. For example, where there are three power lines 84 and three sensors 88, the matrix mask may be a 3×3 matrix mask which captures both phase and polarity errors. However, it is contemplated that other configurations may create similar linear combinations of known errors that may be assigned a unique matrix in a similar manner without departing from the scope of the present disclosure.

A set 132 of the 48 potential matrix masks 134 is shown in FIG. 4. Each matrix mask 134 corresponds to a specific configuration of three current sensors 88 connected to three power lines 84 (referred to as L1, L2, and L3) such that there is one sensor 88 (referred to i1, i2, and i3) per line 84. Each row of a matrix mask 134 corresponds to a respective sensor (i1, i2, or i3), and each column of the matrix mask 134 corresponds to a respective power line 84 (L1, L2, or L3). In addition, a value of “1” is used in a row of the matrix mask 134 to indicate to which line (L1, L2, or L3) the sensor 88 is connected for the corresponding configuration. The “1” appears as a negative value if the sensor 88 is connected to the line 84 backwards such that the sensor's polarity is reversed.

As an example, referring to FIG. 4, the matrix mask 134 associated with an index value of “0” corresponds to the one configuration for which there are no installation errors. For illustration purposes, assume that no installation errors means that sensor i1 is connected to line L1 with the correct polarity, i2 is connected to L2 with the correct polarity, and i3 is connected to L3 with the correct polarity. The matrix mask associated with the “0” index is reproduced below in Table 1.

TABLE 1
Exemplary Matrix Mask for Index “0” of FIG. 4

| | Line Voltage | Line Voltage | Line Voltage |
|---|---|---|---|
| | L1-N | L2-N | L3-N |
| Current Sensor i1 | 1 | 0 | 0 |
| Current Sensor i2 | 0 | 1 | 0 |
| Current Sensor i3 | 0 | 0 | 1 |

As shown in FIG. 4 and by Table 1 above, the as-installed configuration, or index “0” includes: (1) a positive value “1” where L1 and i1 intersect (indicating that i1 is connected to L1 with the correct polarity), (2) a positive value “1” where L2 and i2 intersect (indicating that i2 is connected to L2 with the correct polarity), and a positive value “1” where L3 and i3 intersect (indicating that i3 is connected to L3 with the correct polarity). Thus, the matrix mask 134 associated with the “0” index corresponds to the correct sensor configuration.

The matrix mask 194 associated with the “7” index (which is reproduced below in Table 2), however, corresponds to a sensor configuration having several errors. Specifically, the value of “1” at the intersection of i1 and L1 indicates that the sensor i1 is connected to L1 and, thus is connected to the correct power line. However, the negative value indicates that the polarity of sensor i1 is incorrect (i.e., reversed). Further, the value of “1” at the intersection of i3 and L2 indicates that sensor i3 is connected to L2, noting that such connection is incorrect. Specifically, for the installation to be correct, the sensor i3 should be connected to L3, not L2, as indicated above. In addition, the value of “1” at the intersection of i2 and L3 indicates that sensor i2 is connected to L3, noting that such connection is incorrect. Specifically, for the installation to be correct, the sensor i2 should be connected to L2, not L3, as indicated above. Thus, the matrix mask 134 associated with index “7” corresponds to a sensor misconfiguration where there are two errors (i.e., sensor i1 is connected to the correct power line but is reversed and sensors i2 and i3 are swapped). That is, sensor i2 is connected to the power line that should be connected to i3, and i3 is connected to the power line that should be connected to i2. The other matrix masks (except the “0” index mask) similarly indicate other combinations of installation error.

TABLE 2
Exemplary Matrix Mask for Index “7” of FIG. 4

| | Line Voltage | Line Voltage | Line Voltage |
|---|---|---|---|
| | L1-N | L2-N | L3-N |
| Current Sensor i1 | −1 | 0 | 0 |
| Current Sensor i2 | 0 | 0 | 1 |
| Current Sensor i3 | 0 | 1 | 0 |

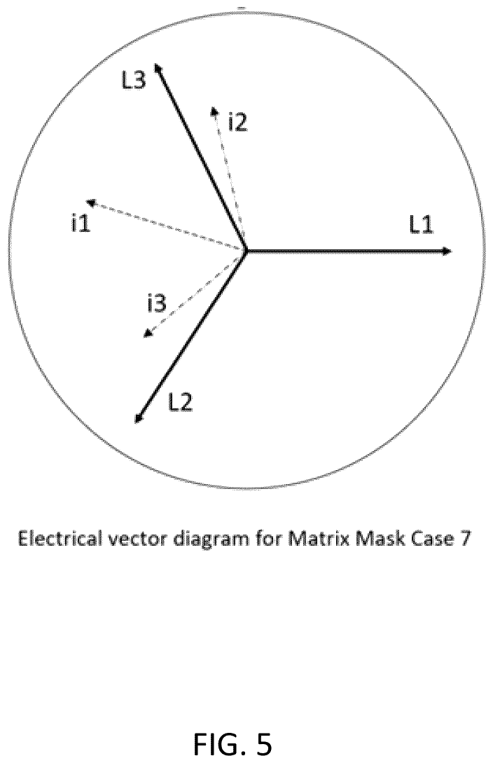

The exemplary matrix masks 134 can be used to create vector diagrams for each sensor misconfiguration. For example, the vector diagram representative of the exemplary matrix mask 134 for Index “7” of FIG. 4 is shown in FIG. 5. The control logic 126 is configured to apply each matrix mask 134 to the sensor data 130, according to the Circuit Power equation set forth above, and for each matrix mask 134, calculate the potential power value expected assuming that the current sensors 88 are connected to the power lines 84 according to the sensor configuration corresponding to the mask 134. The control logic 126 is then configured to compare the resulting power values for each of the masks 134, including index “0” that is as-installed and assumes no errors. As previously described, the calculation of a power value for a given sensor configuration can be done by applying the corresponding matrix mask 134 to the sensor data 130 to calculate the vector dot product that yields the expected power when the sensors are connected to the power lines according to the sensor configuration.

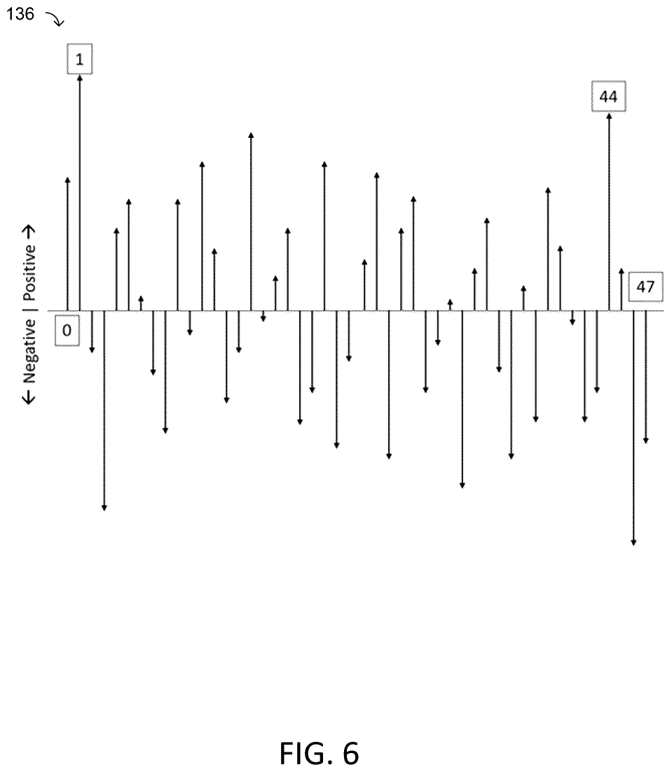

FIG. 6 is a graphical representation of a set 136 of the 48 calculated power values using the 48 matrix masks 134 each applied to the same sample or same set of samples of the sensor data 130. Each arrow of FIG. 6 represents the power value calculated for a respective one of the 48 matrix masks 134, where a longer arrow represents a larger power value. Note that values surrounded by a box in FIG. 6 represent the index value associated with the matrix mask 134 from which the power value was calculated. As an example, the left-most arrow is associated with the “0” index, and the right-most arrow is associated with the “47” index. Once the power calculation using a vector dot product is performed for the sensor data 130 with each matrix mask 134, the resulting power value data points include an equal number of positive and negative values, as shown in FIG. 6. If the sensors 88 are properly positioned and there are no installation errors, the power value for index “0” will have the highest positive power value. However, if there are installation errors, one or more of the other 47 combinations will have a higher positive power value calculated by the control logic 126. The matrix mask 134 that yields the highest power value is likely indicative of the current configuration of the sensors 88. That is, the sensors 88 are likely configured according to the sensor configuration indicated by the matrix mask 134 that yields the highest power value when the matrix masks 134 are applied to the sensor data 130. The assumption is that, because the system is designed to deliver power, the most likely correct installation configuration of the sensors 88 is the one that reads the highest amount of power. In other words, it is unlikely that errors in the installation of the sensors 88 would result in a higher power reading than is actually being provided.

It is generally expected that two matrix masks 134 will be associated with the largest positive power values, which will be comparable or relatively close to each other such that either such matrix mask 134 may correspond to the actual misconfiguration of the sensor 88. The control logic 126 is configured to identify each of the two matrix masks 134 that have the largest power values as a first candidate misconfiguration of the plurality of sensors 88 and a second candidate misconfiguration of the plurality of sensors 88. As will be described in more detail, the control logic 126 then further analyzes the candidate misconfigurations to decide which one likely represents the actual sensor configuration so that the likely installation errors affecting the system can be identified.

For example, in FIG. 6, several of the power values calculated for matrix masks 134 corresponding to sensor misconfigurations are greater than the power value calculated for matrix mask 134 associated with the “0” index (which corresponds to a correct sensor configuration). This indicates that the sensors 88 are likely misconfigured. In addition, power values calculated for the matrix mask 134 of index “1” and for the matrix mask 134 of index “44” are the largest positive numbers, indicating that such matrix masks 134 are the possible candidates for indicating the current misconfiguration of the sensors 88. In other words, one of these matrix masks 134 represents a sensor misconfiguration (or a combination of errors) that has likely occurred and needs to be corrected.

The control logic 126 is then configured to calculate the potential value of the system VAR for the sensor data 130 as installed (i.e., with the matrix mask 134 of index “0” applied) and for each matrix mask 134 of set of matrix masks 134 representing the 48 combinations of errors and compare the resulting VAR values for at least the candidate misconfigurations. In various examples, this calculation can be done using a vector cross product for each sensor configuration by applying the corresponding matrix mask 134 to the sensor data 130, according the Circuit Var equation set forth above.

It is generally expected that one of the two candidate misconfigurations will yield a positive VAR value and the other will yield a negative VAR value. A load that has positive VAR is inductive, and a load that has a negative VAR is capacitive. Thus, the correct candidate misconfiguration (i.e., the candidate misconfiguration associated with a combination of installation errors representative of the actual installation errors in the current configuration of the sensors) may be assumed to be the one having a VAR that corresponds to the correct type of load for the system. For example, if the actual load of the system is inductive, then the candidate misconfiguration that yields a positive VAR value is selected as representative of the actual installation errors of the sensors 88. However, if the actual load of the system is capacitive, then the candidate misconfiguration that yields a negative VAR value is selected as representative of the actual installation errors of the sensors 88.

There are various techniques that may be used to select the correct candidate misconfiguration based on corresponding VAR values. In one embodiment, the control logic 126 may be configured to transmit information regarding the first and second candidate misconfigurations (including information indicative of the calculated VAR values) from the controller 92 to a computing device 68 which may include an output device 70 and/or an input device 66, and such information may be displayed to a user by the output device 70. The user (with knowledge of the type of load connected to the circuit) may be able to identify which of the first and second candidate misconfigurations is correct. The control logic 126 may be configured to receive and store the selection from the user as user input data 138 within the memory 114 of the controller 92.

In another embodiment, the control logic 126 may be configured to assess automatically whether the connected load is capacitive or inductive and then appropriately select the correct candidate misconfiguration. As an example, the control logic 126 may be configured to calculate the harmonic content of each of the first and second candidate misconfigurations to determine a quantitative measurement of the distortion of the underlying waveform to determine if the sensor data 130 is from a inductive system or a capacitive system. The control logic 126 is configured to calculate the harmonic content for each of the first and second candidate misconfigurations by applying the respective matrix mask 134 for each combination to the sensor data 130 according to the following formulae:

$$P {F}_{T H D} = \sqrt{\frac{1}{1 + {( THD )}^{2}}}$$

where, PF_{THD} is the distortion power factor and is computed from the formula:

$$P {F}_{THD} = \frac{P {F}_{A pparent}}{P {F}_{Displacement}}$$

where PF_{Apparent} is the apparent power factor calculated using the sensor data 130 but without taking into account phase angle differences and harmonic content, PF_{Displacement} is the displacement power factor calculated using the sensor data 130, and THD is the total harmonic distortion.

In various examples, the control logic 126 is configured to analyze the values of the total harmonic distortion for each of the first and second candidate configurations to select which of the candidate misconfigurations is correct based on the power factor and total harmonic distortion values. For example, the control logic 126 is configured to use a default rule to select the inductive solution (i.e., the candidate misconfiguration that yields a positive VAR value) as the solution for correcting the actual sensor configuration unless the capacitive solution (i.e., the candidate misconfiguration that yields a negative VAR value) has both a power factor greater than about 0.97 and a total harmonic distortion value of above about 7%. However, it is contemplated that the default rule may be adjusted to allow comparison of the calculated power factor value and the total harmonic distortion value to other parameter value ranges without departing from the scope of the present disclosure.

Where a user does not agree with the outcome from application of the default rule or otherwise does not want the control logic 126 to apply the default rule, a user can select a pre-programmed rule for selecting potential solution via the computing device 68 (e.g., through the input device 66). In other examples, where a user does not agree with or want the control logic 126 to apply the default rule, the user can provide a unique rule for selecting the potential solution via the computing device 68 (e.g., through the input device 66). Where a user provides a unique rule for the control logic 126 to apply when determining which of the first and second candidate misconfigurations is most likely representative of the current misconfiguration (i.e., the current errors in the installation) of the sensors 88 on the lines 84, the controller 92 is configured to receive and store the unique rule from the user in the memory 114 of the controller 92 as user input data 138. The control logic 126 will then use the user input data 138 when determining the suggest solution provided to the output device 70 through the output interface 128.

The control logic 126 may be configured to convert the matrix masks 134 of one or both of the first and second candidate misconfigurations into procedural steps for physically updating the location of the sensors 88 within the power energy meter board 64. For example, after selecting one of the candidate misconfigurations as correct, the control logic 126 may assume that the installation errors of the sensors 88 correspond to the errors indicative by the matrix mask 134 of the candidate misconfiguration deemed to be correct. Thus, the control logic 126 may provide a list of steps to be performed to correct the installation errors. As an example, if the matrix mask 134 of the correct misconfiguration indicates that polarity of sensor i1 is reversed, the control logic 126 may provide an instruction indicating that sensor 88 on line L1 should be turned around. If the matrix mask 134 of the correct misconfiguration indicates that sensors i2 and i3 are swapped, the control logic 126 may provide instructions to (1) remove the sensor 88 on line L2 and connect it to line L3 and (2) remove the sensor 88 of line L3 and connect it to line L2. Thus, by following the provided instructions, the actual sensor installation errors should be corrected.

Alternatively, where the sensors 88 can be accessed remotely or through a register using an external interface, a software tool containing the algorithm can be configured to update the control logic 126 to automatically adjust future sensor data 130 being reported by the controller 92 to account for the correct misconfiguration. As an example, if sensors i2 and i3 are swapped, as described above, then the control logic 126 can be re-configured to treat the measurement from i2 as representative of the current on line L3 and to treat the measurement from i3 as representative of the current on line L2. Thus, future calculations of power value should be correct despite the fact that two sensors 88 are connected to the wrong lines 84. Such techniques allow a user to repair installations remotely instead of having to physically access the sensors 88, which can be costly and time consuming. In other embodiments, the control logic 126 may be configured to make the appropriate adjustments based on the determine misconfiguration without any additional user involvement. Various other techniques for using the identified misconfiguration to take actions for mitigating the installation errors are possible.

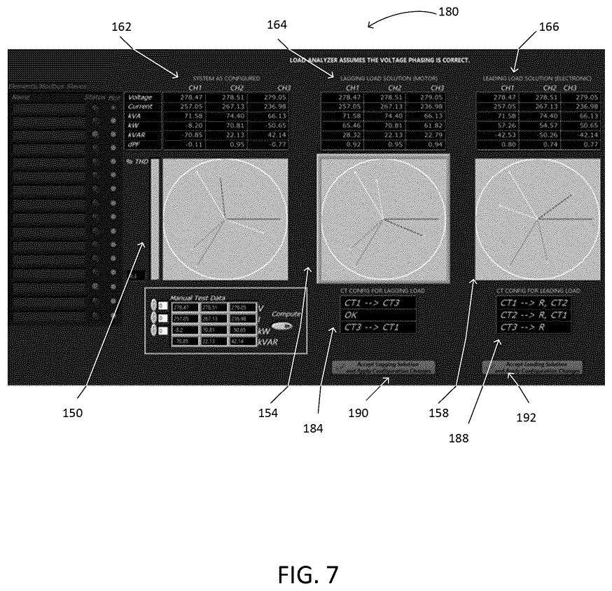

In various examples, as shown in FIG. 7, the control logic 126 may be configured to produce a first vector diagram 150 illustrating the current configuration of the sensors 88 (i.e., with the matrix mask 134 of index “0” applied assuming no errors in installation of the sensors 88). When the first and second candidate misconfigurations are identified, the respective matrix masks 134 may be applied to the first vector diagram 150 to generate a second vector diagram 154 showing the sensor data 130 adjusted by the matrix mask 134 of the first candidate misconfiguration and a third vector diagram 158 showing the sensor data 130 adjusted by the matrix mask 134 of the second candidate misconfiguration. The control logic 126 may then be configured to communicate with the output device 70 via the output interface 128 to display a comparison screen 148 as shown in FIG. 7. For example, in FIG. 7, the two candidate misconfigurations identified are index “5” and index “44”. The second vector diagram 154 shows the first vector diagram 150 with the matrix mask 134 of index “5” applied, and the third vector diagram 158 shows the first vector diagram 150 with the matrix mask 134 of index “55” applied.

As shown in FIG. 7, the first, second, and third vector diagrams 150, 154, 158 are displayed via the output device 70 which may display the diagrams 150, 154, 158 on a display 180. The sensor data 130 is displayed above the first vector diagram 150 in a first display table 162. In other words, the sensor data 130 is displayed with the matrix mask 134 of index “0” applied. A first corrected set of sensor data 164 (i.e., the sensor data 130 with the matrix mask 134 of the first candidate misconfiguration applied) is displayed in a second display table 166 above the second vector diagram 154. In the example shown in FIG. 7, the first corrected set of sensor data 164 shows the sensor data 130 with the matrix mask 134 of index “5” applied. A second corrected set of sensor data 168 (i.e., the sensor data 130 with the matrix mask 134 of the second candidate misconfiguration applied) is displayed in a third display table 170 above the third vector diagram 158. In the example shown in FIG. 7, the second corrected set of sensor data 168 shows the sensor data 130 with the matrix mask 134 of index “44” applied. This is configured to allow a user to compare the current configuration with the first and second candidate misconfigurations to determine the correct misconfiguration of the sensors 88.

The control logic 126 may further transmit to the computing device 68, and the computing device 68 may display via an output device 70, a first summary of procedural steps 184 for adjusting the sensors 88 and/or the sensor data 130 for the first candidate misconfiguration and a second summary of procedural steps 188 for adjusting the sensors 88 and/or the sensor data 130 for the second candidate misconfiguration. The procedural steps 184, 188 may be displayed proximate the respective vector diagram 154, 158. For example, where the matrix mask 134 of Table 1 above is found to correctly represent the first candidate misconfiguration of the system, the procedural steps would include reversing the sensor 88 for the first power line 84, moving the sensor 88 positioned on the second power line 84 to the third power line 84, and moving the sensor 88 positioned on the third power line 84 to the second power line 84. As shown in FIG. 7, where the matrix mask 134 of the second vector diagram 154 is the correct misconfiguration, the procedural steps 184 would include moving the sensor 88 positioned on the first power line 84 to the third power line 84 and moving the sensor 88 positioned on the third power line 84 to the first power line 84. Where the matrix mask 134 of the third vector diagram 148 is identified as the correct misconfiguration, the procedural steps 188 would include reversing the sensors 88 on each power line 84, swapping the sensor 88 on the first power line 84 to the second power line, and swapping the sensor 88 on the second power line 84 to the first power line 84. Alternatively, the procedural steps 184, 188 could be configured to have the control logic 126 adjust sensor data 130 received from the sensors 88 to appropriate reflect the adjustment.

The computing device 68 may further provide via an input device 66 an actuation element 190, 192 for each of the first candidate misconfiguration and the second candidate misconfiguration. A user may select the respective actuation element 190, 192 to instruct the control logic 126 to apply the selected candidate misconfiguration as the correct misconfiguration for the sensor data 130 reported. As previously introduced, in various examples, the computing device 68 may include a single display constituting the input device 66 and the output device 70 such that the actuation elements 190, 192 are displayed proximate the respective vector diagram 154, 158. User selection using the actuation elements 190, 192 may be transmitted to the controller 92 via the input interface 124 and stored as user input data 138 as previously described.

In various examples, the control logic 126 may further be configured to determine if the sensors 88 installed are the correct types of sensors. For example, the control logic 126 may be configured to determine if one or more of the sensors 88 is a Rogowski coil type current sensor mistakenly installed in place of a magnetic transformer current sensor. The control logic 126 may be configured to analyze voltage values (e.g., amplitudes) of the sensor data 130 collected by one or more sensors 88 over time to determine the phase of each power signal carried by a respective power line 84. There is typically a 90 degree phase shift difference between a Rogowski coil current sensor and a magnetic transformer sensor. Thus, phases can be analyzed and compared to determine if at least one power signal has a phase shift indicative of a sensor type use that is different than expected. If the control logic 126 detects use of an incorrect sensor type, the control logic 126 may provide notice of the error or correct the sensor data 130, as described above for other types of errors detected by the control logic 126. In other embodiments, other techniques for detecting sensor type and errors based on sensor type are possible.

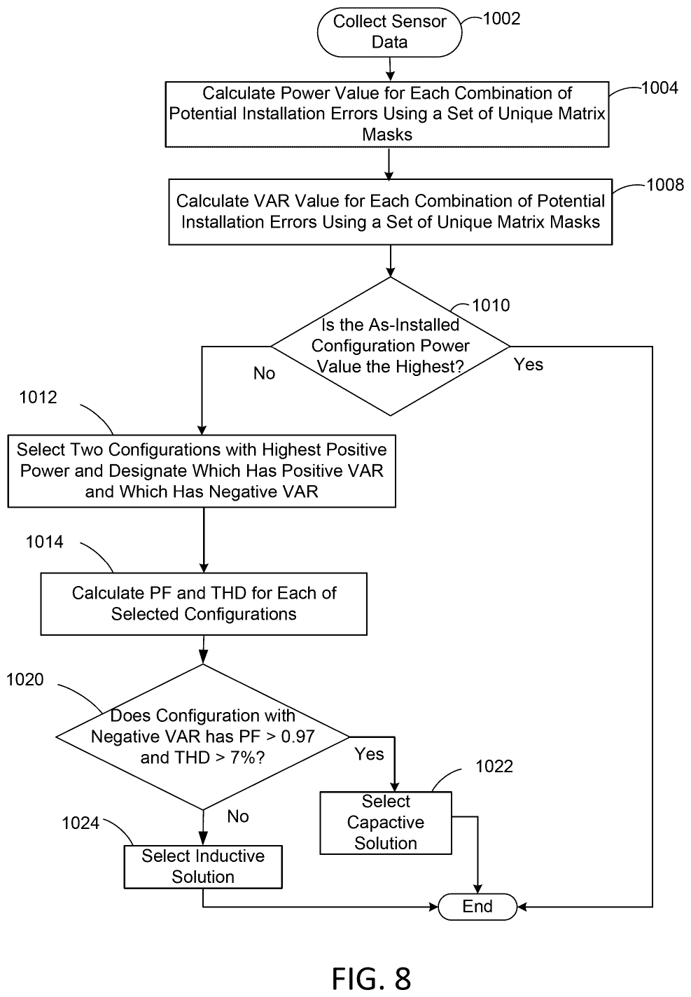

FIG. 8 depicts an exemplary process of determining configuration correction of the power monitoring system 50. When the sensor data 130 is stored within the memory 114 of the controller 92, the control logic 126 is configured to calculate values for at least power for each possible configuration (where each configuration is associated with a respective combination (one or more) installation errors) in step 1004. The control logic 126 may also be configured to calculate values for VAR (step 1008) and to analyze the calculated values to determine if the as-installed configuration produced the highest calculated power value (step 1010). If the as-installed configuration produces the highest calculated power value, then the sensors 88 are correctly installed and the process ends. If the as-installed configuration does not produce the highest calculated power value, then the control logic 126 selects the two configurations with the highest positive power as candidate misconfigurations and designates which has a matrix mask 134 that, when applied to the sensor data 130, generates a positive value for VAR and which has a matrix mask 134 that, when applied to the sensor data 130, generates a negative VAR (step 1012). The control logic 126 is then configured to calculate the power factor (PH) and harmonic distortion (THD) for the sensor data 130 when the matrix mask 134 of each of the positive VAR solution is applied to the sensor data 130 and when the matrix mask 134 of the negative VAR solution is applied to the sensor data 130 in step 1014. The control logic 126 then determines if the candidate configuration with negative VAR has a PF>about 0.97 and a THD>about 7% in step 1020. If the answer is yes, the control logic 126 selects the capacitive solution (i.e., the candidate configuration associated with a negative VAR value) in step 1022. If the answer is no, the control logic 126 selects the inductive solution (i.e., the candidate misconfiguration associated with a positive VAR value) in step 1024. Once a solution is selected in either step 1022 or step 1024, the process ends.

As noted above, additional steps may then be taken to compensate for the identified misconfiguration. As an example, the sensors 88 may be physically rearranged to correct for the installation errors indicated by the identified misconfiguration, or the sensor data 130 of future measurements may be adjusted to account for such installation errors.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power meter for monitoring power signals from three-phase power lines, comprising:
a plurality of sensors coupled to at least one power line, the plurality of sensors configured to sense at least one parameter of at least one power signal carried by the at least one power line; and
at least one processor configured to receive sensor data indicative of measurements of the at least one power signal by the plurality of sensors, the at least one processor configured to calculate a plurality of power values indicating an amount of power expected, based on the sensor data, to have been delivered through the at least one power line for a respective configuration of the plurality of sensors including at least:
a first power value indicating an amount of power expected, based on the sensor data, to have been delivered through the at least one power line for a correct configuration of the plurality of sensors;
a second power value indicating an amount of power expected, based on the sensor data, to have been delivered through the at least one power line for a first misconfiguration of the plurality of sensors; and
a third power value indicating an amount of power expected, based on the sensor data, to have been delivered through the at least one power line for a second misconfiguration of the plurality of sensors;
wherein the at least one processor is further configured to compare the plurality of power values, including at least the first power value, the second power value, and the third power value, and to identify a current misconfiguration of the plurality of sensors based on a comparison of the plurality of power values.

2. The power meter of claim 1, further comprising memory for storing a set of predefined matrix masks having a plurality of matrix masks, including at least a first matrix mask correlated with the correct configuration, a second matrix mask correlated with the first misconfiguration, and a third matrix mask correlated with the second misconfiguration, wherein the at least one processor is configured to calculate the plurality of power values by performing a vector dot product multiplication of the sensor data with each of the plurality of matrix masks.

3. The power meter of claim 2, wherein the at least one processor is configured to select, based on the comparison, one of the plurality of power values associated with the current misconfiguration of the plurality of sensors, and identify one of the plurality of matrix masks used to calculate the one of the plurality of power values associated with the current misconfiguration of the plurality of sensors, wherein identification of the current misconfiguration is based on the identified one of the matrix masks.

4. The power meter of claim 3, wherein the at least one processor is configured to determine, based on the identified one of the matrix masks, a plurality of adjustments to be applied to second sensor data from the plurality of sensors for correcting the second sensor data for the current misconfiguration.

5. The power meter of claim 2, wherein the at least one processor is configured to communicate with a user device, the at least processor configured to communicate identification of the current misconfiguration to the user device to be displayed by the user device.

6. The power meter of claim 1, wherein at least one of the plurality of sensors is configured to measure a voltage of the at least one power signal, and wherein at least one of the plurality of sensors is configured to measure a current of the at least one power signal.

7. A power monitoring system for monitoring power signals from power lines, comprising:
at least one power line for carrying at least one power signal;
a plurality of sensors coupled to the at least one power line, the plurality of sensors configured to sense at least one parameter of the at least one power signal;
at least one processor configured to receive sensor data indicative of measurements of the at least one power signal by the plurality of sensors, the at least one processor configured to calculate a plurality of power values indicating an amount of power expected, based on the sensor data, to have been delivered through the at least one power line for a respective configuration of the plurality of sensors including at least:
a first power value indicating an amount of power expected, based on the sensor data, to have been delivered through the at least one power line for a correct configuration of the plurality of sensors;
a second power value indicating an amount of power expected, based on the sensor data, to have been delivered through the at least one power line for a first misconfiguration of the plurality of sensors; and
a third power value indicating an amount of power expected, based on the sensor data, to have been delivered through the at least one power line for a second misconfiguration of the plurality of sensors,
wherein the at least one processer is further configured to compare the plurality of power values, including at least the first power value, the second power value, and the third power value, and to identify a current misconfiguration of the plurality of sensors based on a comparison of the plurality of power values.

8. The power monitoring system of claim 7, wherein the at least one processor is further configured to apply to the sensor data a set of matrix masks including a plurality of matrix masks including at least a first matrix mask correlated with the correct configuration of the plurality of sensors, a second matrix masks correlated with the first misconfiguration of the plurality of sensors, and a third matrix mask correlated with the second misconfiguration of the plurality of sensors.

9. The power monitoring system of claim 7, wherein the at least one processor is configured to:
calculate a plurality of volt-ampere reactive (VAR) values, including at least a first volt-ampere reactive (VAR) value for the first misconfiguration and a second volt-ampere (VAR) value for the second misconfiguration;
calculate a power factor value and a harmonic distortion value for each of the first misconfiguration of the plurality of sensors and the second misconfiguration of the plurality of sensors; and
identify the current misconfiguration based on the first VAR value and the second VAR value.

10. A computer implemented method, comprising:
receiving sensor data from a plurality of sensors installed on at least one power line, the plurality of sensors configured to sense at least one parameter of at least one power signal carried by the at least one power line;
calculating a plurality of power values using a vector dot product multiplication of the sensor data, including at least a first power value indicating an amount of power expected, based on the sensor data, to have been delivered through the at least one power line for a correct configuration of the plurality of sensors; a second power value indicating an amount of power expected, based on the sensor data, to have been delivered through the at least one power line for a first misconfiguration of the plurality of sensors; and a third power value indicating an amount of power expected, based on the sensor data, to have been delivered through the at least one power line for a second misconfiguration of the plurality of sensors;
comparing the plurality of power values, including at least the first power value, the second power value, and the third power value; and
identifying a current misconfiguration of the plurality of sensors based on the comparison of the plurality of power.

11. The computer implemented method of claim 10, further comprising:
calculating a plurality of volt-ampere reactive (VAR) values using a vector cross product multiplication of the sensor data, including at least a first VAR value for the first misconfiguration of the plurality of sensors, and a second VAR value for the second misconfiguration of the plurality of sensors; and
comparing the plurality of VAR values, including at least the first VAR value and the second VAR value, to identify a current misconfiguration of the plurality of sensors based on a comparison of the plurality of power values and the comparison of the VAR values

12. The computer implemented method of claim 10, further comprising:
applying to the sensor data a set of matrix masks including a plurality of matrix masks including at least a first matrix mask correlated with the correct configuration of the plurality of sensors, a second matrix masks correlated with the first misconfiguration of the plurality of sensors, and a third matrix mask correlated with the second misconfiguration of the plurality of sensors.

13. The computer implemented method of claim 10, further comprising:
calculating a power factor value and a harmonic distortion value for each of the first misconfiguration of the plurality of sensors and the second misconfiguration of the plurality of sensors; and
identifying the current misconfiguration based on the power factor value and the harmonic distortion value.

14. A non-transitory computer readable medium comprising instructions that, when executed by one or more processors, cause the one or more processors to:
receive sensor data from a plurality of sensors installed on at least one power line, the plurality of sensors configured to sense at least one parameter of at least one power signal carried by the at least one power line;
apply to the sensor data a set of matrix masks including a plurality of matrix masks including at least a first matrix mask correlated with a correct configuration of the plurality of sensors, a second matrix masks correlated with a first misconfiguration of the plurality of sensors, and a third matrix mask correlated with a second misconfiguration of the plurality of sensors;
perform a vector dot product multiplication of each matrix masks of the plurality of matrix masks with the sensor data to calculate a plurality of power values indicating an amount of power expected, based on the sensor data and the plurality of matrix masks, to have been delivered through the at least one power line, wherein the plurality of power values includes at least (1) a first power value indicating an amount of power expected, based on the sensor data and the first matrix mask, to have been delivered through the at least one power line for the correct configuration, (2) a second power value indicating an amount of power expected, based on the sensor data and the second matrix mask, to have been delivered by the at least one power line for the first misconfiguration of the plurality of sensors, and (3) a third power value indicating an amount of power expected, based on the sensor data and the third matrix mask, to have been delivered by the at least one power line for the second misconfiguration of the plurality of sensors; and
select one of the first misconfiguration and the second misconfiguration as being a current misconfiguration of the plurality of sensors.

15. The non-transitory computer readable medium of claim 14, wherein the one or more processors are further configured to:
perform a vector cross product multiplication of the second matrix mask with the sensor data to calculate a first volt-ampere reactive (VAR) value for the first misconfiguration;
perform a vector cross product multiplication of the third matrix mask with the sensor data to calculate a second volt-ampere reactive (VAR) value for the second misconfiguration; and
compare the first VAR value with the second VAR value to identify the first misconfiguration as having an overall inductive characteristic and to identify the second misconfiguration as having an overall capacitive characteristic.
